(19) United States
(12) Patent Application Publication
(10) Pub. No.: US 2026/0059054 A1
(43) Pub. Date: Feb. 26, 2026

(54) SYSTEMS AND METHODS FOR ORCHESTRATING INTERACTION WITH AN ARTIFICIAL INTELLIGENCE APPLICATION

(71) Applicant: THE BANK OF NEW YORK MELLON, New York, NY (US)

(72) Inventors: Ace GAMBOA, New York, NY (US); Anil Kiran VELLALA, New York, NY (US); Benjamin Nien-Ting WU, New York, NY (US); Anthony QUIZON, New York, NY (US)

(21) Appl. No.: 19/209,243

(22) Filed: May 15, 2025

Related U.S. Application Data
(60) Provisional application No. 63/685,305, filed on Aug. 21, 2024.

(51) Int. Cl. H04M 3/527; G10L 13/08; G10L 15/26; G10L 17/26

(52) U.S. Cl. CPC H04M 3/527; G10L 13/08; G10L 15/26; G10L 17/26

(57) ABSTRACT

Systems and methods for orchestrating interaction with an artificial intelligence (AI) application in a contact center environment receive, via an AI agent, a voice message from a user; convert the message from voice to text; generate an initial computational inference process based on the text message; determine whether or not all information required to execute the initial computational inference process is available to the processor; when a determination is made that all information required is available: execute the initial computational inference process; generate a text reply based on the initial computational inference process; convert the text reply to a voice reply; and send the voice reply to the user via the AI agent; when a determination is made that information is unavailable: generate a text query requesting the information; convert the text query to a voice query; and send the voice query to the user via the AI agent.

### CROSS-REFERENCE TO RELATED APPLICATIONS

This application claims priority to U.S. Provisional Application No. 63/685,305, filed Aug. 21, 2024, the subject matter of which is incorporated herein by reference in its entirety.

### BACKGROUND

There are numerous challenges of developing and maintaining artificial intelligence (AI)-driven applications, including ensuring that they can handle incomplete and/or missing data gracefully and provide meaningful responses and/or feedback to the users. However, in presently available systems and methods, data quality and availability are not always guaranteed, especially when dealing with complex or dynamic domains. Often, user requests may be vague, ambiguous, incomplete, or inconsistent, making it hard for AI applications to provide accurate and relevant responses or solutions. In such cases, AI applications may either fail silently, return erroneous results, or ask the user to reformulate the request, which can lead to frustration and dissatisfaction among the users, as well as unnecessary wasting of processing resources.

A significant challenge that AI applications face is the dependency on data to process user requests. Data is the fuel that powers AI applications and enables them to provide accurate and relevant responses. However, data is often incomplete, noisy, and/or ambiguous, which can lead to suboptimal or erroneous outcomes. For instance, an AI application may need to check the account balance for a user, but it may not have the information about which kind of account, or which account number, the user is referring to. If the application assumes or guesses incorrectly, it could give the wrong information to the user.

This challenge can have serious consequences for the reputation and trustworthiness of the AI application and the service provider. If the AI application gives wrong or irrelevant information, it may cause confusion, frustration, or dissatisfaction for the user, who may lose confidence in the application and the provider. Moreover, if the AI application makes incorrect inferences, calculations, or actions based on incomplete or noisy data, it can lead to financial losses, legal liabilities, or reputational damages for the user and the provider. For at least these reasons, it is important that the AI application does not assume or guess data when it is uncertain, but rather interacts with the user and requests clarification or additional information. This way, the AI application can ensure that it provides accurate and relevant responses and maintains the user's trust and satisfaction.

Presently available systems and methods typically attempt to address these challenges by creating a business process management (BPM) process to manage the dialogue between the AI application and the user. A BPM process is a structured approach that involves using various methods to discover, model, analyze, measure, improve, optimize, and automate business processes.

However, when implementing a BPM process in AI applications, all situations and changes have to be designed and prepared in advance of implementation. And for natural language inputs, only after gathering all the data, an utterance may then be transferred to an AI model, such as a large language model (LLM) for processing. Additionally, a BPM process can be costly and overly complex, often requiring significant upfront investment in software and training. BPM's reliance on overly complex technology may lead to issues if the software is inflexible or fails. Furthermore, continuous maintenance demands ongoing resources, and there is a risk of over-engineering processes, making them overly complex and rigid, which can stifle creativity and flexibility. And because of the rigidity of existing systems and methods, they are unable to automatically retrieve missing information needed to complete the task from a user's follow-up question or another API call.

In addition to the limitations of current systems presented above, other challenges exist in implementing interactions with AI applications. Data is essential for AI applications to be smart. They need to have access to huge amounts of datasets to work well. Data that is used and collected for AI usually needs significant processing and time to analyze. The more varied and complete the data, the better AI can generate results. This is why data is sometimes called the “training fuel” for AI applications.

However, while AI applications rely on data, obtaining and handling the data for AI applications can be hard and time-consuming. Some of the problems are lack of data, diversity, privacy, quality, and labeling. These data problems can hinder or prevent the creation and usage of AI applications, and also increase the cost and complexity of data management. Therefore, there is a demand for solutions that can address these data problems and make it easier and faster to build AI applications.

The conventional systems and methods require collecting large datasets from different sources, and loading them with appropriate segments, tags, and meta data to a storage device. The data can be used to train the model for a specific skill. Another way is storing the data in vector form and using a search engine to find the relevant data in the data store that the AI application will use as a knowledge base for a specific task.

Yet another limitation of current systems presented above is the difficulty in integrating such systems into various environments, such as, for example, a contact center environment. One of the main goals of Contact Center Operations is to provide a satisfactory customer experience and resolve customer issues as quickly and efficiently as possible. To achieve this, human contact center agents need to have the skills and knowledge to handle various types of customer queries, ranging from simple requests to complex problems. They also need to be able to adapt to different situations, such as switching topics, clarifying information, or escalating issues to higher levels of support. However, training and retaining qualified agents can be costly and time-consuming, and there is always a risk of human error or inconsistency in service quality. Therefore, Contact Center Operations are looking for ways to automate some of their tasks and enhance their performance with the help of technology.

One of the approaches to help automate at least a portion of Contact Center Operations is to use BPM workflows (as described herein) that create predefined conversation flows for specific customer intents or topics. For example, a workflow can guide a customer through the steps of booking a flight, checking the status of an order, or resetting a password. The workflow can also integrate with other systems, such as databases, payment gateways, or CRM platforms, to perform actions or retrieve information. This way, the workflow can handle the customer query without the need for human intervention, or with minimal supervision.

However, BPM workflows have limitations when it comes to dealing with the dynamic and unpredictable nature of human conversations. First, they require substantial design and maintenance effort, as each conversation type needs a different workflow. Second, they are rigid and inflexible, as they can only process the customer input that matches the expected format and structure of the workflow. Third, they are not able to handle situations where the customer wants to switch to a different topic, ask additional questions, or provide feedback. In these cases, the workflow either fails or transfers the customer to a live agent, which can result in frustration and dissatisfaction.

An alternative is to leverage AI models (e.g., LLMs) and AI capabilities to process the user messages. AI is an effective method to comprehend the user speech and give answers from the data that it was trained on. However, present systems and methods lack the ability to ask further questions, gather the necessary inputs from other sources based on the user's request, or explain its reasoning in dealing with the request. Present systems and methods cannot automatically obtain the information that is not available to complete the task from a user's subsequent question or a different API call and figure out an execution plan to fulfill the user's requests.

Yet another limitation of current systems presented above, are the challenges that arise when implementing frameworks that interact with AI models e.g., (LLMs) such that the framework needs to know the available functions (in order to call them when needed). In such circumstances, current systems are unable to load only the functions the AI model is configured to use, causing a large processing drain on the system.

This disclosure describes dynamically loading a required set of functions based on intent of the question that can further improve performance.

### BRIEF SUMMARY

Aspects of the disclosure relate to systems, methods, apparatuses, and/or systems for orchestrating interaction with an AI application.

In some aspects, the techniques described herein relate to a method for orchestrating interaction with an artificial intelligence application in a contact center environment, including: receiving, by a processor, via an artificial intelligence (AI) agent, a first voice message from a user; converting, by the processor, the first voice message to a first text message; generating, by the processor, an initial computational inference process based at least in part on the first text message; determining, by the processor, whether or not all information required to execute the initial computational inference process is available to the processor; when a determination is made that all information required to execute the initial computational inference process is available to the processor: executing, by the processor, the initial computational inference process; generating, by the processor, a first text reply based on the initial computational inference process; converting, by the processor, the first text reply to a first voice reply; and sending, by the processor, the first voice reply to the user via the AI agent; when a determination is made that not all information required to execute the initial computational inference process is available to the processor: generating, by the processor, a first text query requesting the unavailable information from the user; converting, by the processor, the first text query to a first voice query; and sending by the processor, the first voice query to the user via the AI agent.

In some aspects, the techniques described herein relate to a method, further including: receiving, by the processor, via the AI agent, a second voice message from a user; converting, by the processor, the second voice message to a second text message; generating, by the processor, a revised computational inference process based at least in part on the second text message; executing, by the processor, the revised computational inference process; generating, by the processor, a second text reply based on the revised computational inference process; converting, by the processor, the second text reply to a second voice reply; and sending, by the processor, the second voice reply to the user via the AI agent.

In some aspects, the techniques described herein relate to a method, wherein the first voice message is converted to the first text message via a voice-to-text (VTT) engine.

In some aspects, the techniques described herein relate to a method, wherein the first text message is converted to the first voice reply via a text-to-voice (TTV) engine.

In some aspects, the techniques described herein relate to a method, wherein, when determining whether all required information is available, the processor is further configured to determine at least one of: which API or APIs of a plurality of APIs is required to respond to the first voice message; or which function or functions of a plurality of functions is required to respond to the first voice message.

In some aspects, the techniques described herein relate to a method, wherein the AI agent is further configured to analyze the user's voice message for at least one of tone, sentiment, or urgency, and modify the computational inference process based at least in part on the detected sentiment to prioritize urgent requests or escalate the interaction to a human agent.

In some aspects, the techniques described herein relate to a method, wherein determining whether all required information is available further includes querying a historical conversation database to retrieve prior interactions with the user, and using previously provided information to supplement the computational inference process before requesting additional user input.

In some aspects, the techniques described herein relate to a method, wherein generating the first text query further includes structuring the query dynamically based on natural language processing (NLP) techniques before converting the text query to a voice query.

In some aspects, the techniques described herein relate to a method, further including verifying the accuracy of the voice-to-text conversion by applying an AI-based confidence scoring mechanism, and in response to detecting a low confidence score, prompting the user to confirm or clarify the converted message before proceeding with computational inference.

In some aspects, the techniques described herein relate to a method, wherein the processor is further configured to determine whether the AI agent should rephrase or simplify the first voice reply based on the complexity of the generated response and the user's past interaction history, ensuring responses are tailored to the user's preferred communication style.

In some aspects, the techniques described herein relate to a system for orchestrating interaction with an artificial intelligence application in a contact center environment, including: a computer having a processor and a memory; and one or more code sets stored in the memory and executed by the processor, which, when executed, configure the processor to: receive, via an artificial intelligence (AI) agent, a first voice message from a user; convert the first voice message to a first text message; generate an initial computational inference process based at least in part on the first text message; determine whether or not all information required to execute the initial computational inference process is available to the processor; when a determination is made that all information required to execute the initial computational inference process is available to the processor: execute the initial computational inference process; generate a first text reply based on the initial computational inference process; convert the first text reply to a first voice reply; and send the first voice reply to the user via the AI agent; when a determination is made that not all information required to execute the initial computational inference process is available to the processor: generate a first text query requesting the unavailable information from the user; convert the first text query to a first voice query; and send the first voice query to the user via the AI agent.

In some aspects, the techniques described herein relate to a system, further configured to: receive, via the AI agent, a second voice message from a user; convert the second voice message to a second text message; generate a revised computational inference process based at least in part on the second text message; execute the revised computational inference process; generate a second text reply based on the revised computational inference process; convert the second text reply to a second voice reply; and send the second voice reply to the user via the AI agent.

In some aspects, the techniques described herein relate to a system, wherein the first voice message is converted to the first text message via a voice-to-text (VTT) engine.

In some aspects, the techniques described herein relate to a system, wherein the first text message is converted to the first voice reply via a text-to-voice (TTV) engine.

In some aspects, the techniques described herein relate to a system, wherein, when determining whether all required information is available, the processor is further configured to determine at least one of: which API or APIs of a plurality of APIs is required to respond to the first voice message; or which function or functions of a plurality of functions is required to respond to the first voice message.

In some aspects, the techniques described herein relate to a system, wherein the AI agent is further configured to analyze the user's voice message for at least one of tone, sentiment, or urgency, and modify the computational inference process based at least in part on the detected sentiment to prioritize urgent requests or escalate the interaction to a human agent.

In some aspects, the techniques described herein relate to a system, wherein determining whether all required information is available further includes querying a historical conversation database to retrieve prior interactions with the user, and using previously provided information to supplement the computational inference process before requesting additional user input.

In some aspects, the techniques described herein relate to a system, wherein generating the first text query further includes structuring the query dynamically based on natural language processing (NLP) techniques before converting the text query to a voice query.

In some aspects, the techniques described herein relate to a system, further configured to verify the accuracy of the voice-to-text conversion by applying an AI-based confidence scoring mechanism, and in response to detecting a low confidence score, prompt the user to confirm or clarify the converted message before proceeding with computational inference.

In some aspects, the techniques described herein relate to a system, wherein the processor is further configured to determine whether the AI agent should rephrase or simplify the first voice reply based on the complexity of the generated response and the user's past interaction history, ensuring responses are tailored to the user's preferred communication style.

Various other aspects, features, and advantages will be apparent through the detailed description and the drawings attached hereto. It is also to be understood that both the foregoing general description and the following detailed description are exemplary and not restrictive of the scope of the disclosure.

### BRIEF DESCRIPTION OF THE FIGURES

FIG. 1 depicts an illustrative system for orchestrating interaction with an AI application, in accordance with at least one embodiment;

FIG. 2 depicts an example method for orchestrating interaction with an AI application in accordance with at least one embodiment;

FIG. 3 depicts an alternative example method for orchestrating interaction with an AI application is depicted, in accordance with at least one embodiment; and

FIG. 4 depicts an example computing system with which one or more embodiments may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

In the following description, for the purposes of explanation, numerous specific details are set forth in order to provide a thorough understanding of the various embodiments. It will be appreciated, however, by those having skill in the art, that the embodiments may be practiced without these specific details, or with an equivalent arrangement. In other cases, well-known structures and devices are shown in block diagram form in order to avoid unnecessarily obscuring the embodiments of the invention.

The following terminology is used throughout the disclosure:
LLM: An LLM is a type of artificial intelligence model that has been trained on vast amounts of text data to understand and generate human language and/or other content. LLMs use advanced machine learning techniques, particularly deep learning, to predict and produce text based on input prompts. These models are capable of performing a wide range of language-related tasks, including translation, summarization, question answering, and content generation. The key feature of LLMs is their ability to understand context, manage nuances in language, and generate coherent and contextually relevant responses, making them highly valuable for applications in natural language processing (NLP). In some embodiments, an LLM may implement a process of matching the language of a webpage or application to the preferred language of the user. Nonlimiting examples may include GPT4-32K, GPT4-Turbo, etc.
LLM database: is a specialized database that leverages the capabilities of one or more LLMs to enhance data interaction and management. Unlike traditional databases that rely on structured queries and predefined schemas, an LLM database allows users to interact with the data using natural language queries. This makes it easier for non-technical users to access and manipulate data without needing to understand complex query languages. Additionally, LLM databases may provide more intuitive insights and analyses by interpreting the intent behind queries and offering relevant information, summaries, or visualizations. The integration of LLMs into databases transforms the way data is accessed and utilized, making data interaction more user-friendly and efficient.
Artificial Intelligence (AI): is a field of computer science that aims to create machines and systems that can perform tasks that normally require human intelligence, such as reasoning, learning, perception, inference-making, or natural language processing.

AI encompasses a broad range of computational techniques and methodologies designed to enable machines to replicate cognitive functions typically associated with human intelligence. These functions may include, but are not limited to, autonomous decision-making, predictive analytics, problem-solving, and adaptive learning. AI systems often leverage machine learning models, deep learning architectures, neural networks, and natural language processing (NLP) to interpret, analyze, and respond to complex data inputs. By utilizing large datasets and advanced algorithms, AI systems may recognize patterns, generate insights, and execute tasks with increasing accuracy over time, often improving through iterative training and feedback loops.

Beyond conventional rule-based programming, AI incorporates probabilistic reasoning and dynamic modeling, allowing for more sophisticated decision-making in real-world applications. AI systems may be implemented in various domains, including healthcare, finance, autonomous vehicles, robotics, and customer service, among others. Furthermore, AI may function in conjunction with other computational paradigms, such as edge computing, cloud-based AI processing, or federated learning, to optimize performance and scalability.

Artificial intelligence (AI) agent: is a software or application that autonomously performs tasks and/or generates outputs based on its programming and the data it processes. It may perceive its environment through sensors, process information, and take actions to achieve specific goals, often learning and adapting over time. AI agents may be used in various applications, such as virtual assistants, autonomous vehicles, and recommendation systems, leveraging techniques from machine learning, natural language processing, and robotics to enhance their effectiveness and capabilities.

AI application: refers to any software program or system that incorporates AI techniques to perform specific tasks, solve problems, or offer services. AI applications integrate AI algorithms and models with other software components and are designed to address particular problems or provide specific functionalities. They often feature user interfaces for human interaction and can either be part of a larger system or stand-alone software. Examples of AI applications include image recognition software that identifies objects in photos, natural language processing tools that translate languages, and AI-driven diagnostic tools used in healthcare to analyze medical images. AI applications may employ, incorporate, or otherwise implement one or more AI agents to perform tasks and/or generate outputs, such as described herein.

Application Programming Interface (API): A set of rules and specifications that may define how different software components or applications may communicate and interact with each other. An API provides a standardized way of accessing the functionality or data of another system or service. For example, for an account inquiry relating to a specific case, a REST API associated with that case that is capable of returning account details such as balances, holdings, etc., may be implemented.

Function: A segment of code that performs a specific task or operation, typically by taking some input parameter(s) and returning an output value. A code function may be reused in different parts of a program or application, making the code more modular and efficient. Code functions may also be referred to as subroutines, procedures, methods, or routines in different programming languages. Continuing the above example, the REST API may have endpoints such as get_accounts_details, get_transaction_history, and/or other functions, etc.

AI Framework: A set of tools, libraries, and protocols that facilitate the development and deployment of AI applications. An AI framework may provide a common platform for building, testing, and running AI models and algorithms, as well as integrating them with other systems and services. An AI framework may support different types of AI tasks, such as computer vision, natural language processing, speech recognition, or machine learning. Some examples of AI frameworks include, without limitation, Semantic Kernel, LangChain, TensorFlow, PyTorch, Keras, and Scikit-learn.

AI container: in the context of AI, a container refers to a lightweight, standalone, and executable package that includes the components required to run an AI application or model, including the code, runtime, libraries, environment variables, and dependencies. Containers may provide a consistent and isolated environment for running applications, which may enable them to run reliably across different computing environments.

Business Process Management (BPM): A systematic approach to designing, executing, monitoring, and improving business processes.

Reasoning and Action (ReAct): a framework for developing and managing reactive business processes, which are processes that may adapt to changes in the environment and customer needs. ReAct combines BPM concepts with AI techniques, such as event processing, rule-based systems, and machine learning, to enable dynamic and intelligent process execution. ReAct aims to improve process efficiency, agility, and quality by providing tools for modeling, monitoring, and optimizing business processes.

VTT (Voice to Text): A technology that converts spoken language into written text. VTT may be used for transcription, captioning, subtitling, or voice recognition. VTT may also enable natural language processing tasks, such as sentiment analysis, summarization, or translation, on audio data.

TTV (Text to Voice): A technology that converts written text into spoken language. TTV may be used for speech synthesis, text-to-speech, or voice generation. TTV may also enable natural language generation tasks, such as dialogue, narration, or storytelling, on text data.

Computational Inference: As it relates to artificial intelligence (AI), a computational inference refers to the process by which an AI system derives conclusions, generates outputs, or determines appropriate actions based on input data, predefined rules, probabilistic models, or learned patterns. Such inference mechanisms enable AI-driven systems to process user queries, evaluate missing or incomplete data, execute decision-making frameworks, and generate predictions or recommendations. Computational inference may be performed through various reasoning methodologies, including logical deduction, probabilistic assessment, contextual analysis, predictive modeling, and interactive data retrieval. These methodologies collectively allow AI applications to dynamically process and respond to complex inputs, adapting to real-time conditions and refining their outputs based on prior interactions and learned behaviors.

Embodiments described herein: (1) leverage AI agents to process user utterances and other communications (collectively referred to herein as “messages”) to generate a computational inference process; (2) the computational inference process generated may act as the initial plan to address the user's request; (3) an interactive orchestration server may process the initial computational inference process and evaluate generated computational inferences, determine if there is any missing information required to process the request, and query the user or call additional APIs and/or functions to retrieve the information required; (4) send the information back to the AI agent to re-process the computational inference; determine if the thought is complete; (5) execute the plan by executing the API and/or functions; and (6) deliver the final answer to the user.

In some embodiments, the API interface/definitions may serve as the knowledge base for the AI agent needed to create the computational inference process and plan. In some embodiments, an execution engine may be responsible for running the underlying functionality which is connected to an API store. In some embodiments, each time an AI model (e.g., an LLM) produces a “computational inference,” the application code may be configured to evaluate that output to check if it contains instructions to execute a function. If it does, the instructions will specify the function name, and the parameters. The application code may then execute the specified function accordingly.

Systems and methods provided herein enable AI applications to benefit from having the ability to interact with the users, e.g., in natural language, and request for additional information or clarification when needed. In this way, AI applications may be able to fill in data gaps, resolve ambiguities, and refine user requests, resulting in more reliable and satisfactory outcomes. Embodiments described herein provide systems and methods that enable AI applications to engage in natural language dialogues with the users and improve their performance and user experience.

Embodiments of the systems and methods described herein leverage state-of-the-art natural language processing, understanding computational inference process generation techniques to analyze user requests, identify data gaps, generate relevant questions, and update the request with user-provided answers and/or additional API calls to collect the missing data. Embodiments of the systems and methods described herein aim to improve the user experience and satisfaction of AI applications by making them more interactive, adaptive, and intelligent.

For example, in some embodiments, when the system detects that it lacks some information, it may first attempt to check the available functions. By using the function definition, input, and output description, the system may decide what function to use. Furthermore, in some embodiments, the AI model may be aware of the descriptions of the functions that can be used. Accordingly, if the AI model knows, for example, that it needs to use a get_account_details function which requires an account number, it may identify the use of a get_additional_details_from_user function to ask the user to provide the account number.

Embodiments of the systems and methods described herein further enable an AI application to request additional information or clarification from the user when the data is incomplete, noisy, or ambiguous, as described in detail herein. As such, the AI application may fill in the data gaps and provide more accurate and relevant responses. For example, a user might ask an AI application to check an account balance, but the application may not know which account type, number, or currency the user has. Instead of making incorrect assumptions or guesses, embodiments enable the AI application to ask the user to specify the account details and then give the correct information.

Embodiments of the systems and method described herein may identify data that is incomplete, noisy, and/or ambiguous, and may therefore prompt an inquiry for additional information from an end user. For example, the system may prompt an AI model (e.g., an LLM) in a way that the AI model is aware of what the user is asking for, along with the conversation history. Accordingly, in some embodiments, the AI model may also be aware of what functions are available to obtain data needed to generate an answer. The functions may be described along with their required parameters. As such, in some embodiments, the AI model may be configured with cognitive ability to determine if the required parameter is already satisfied, or if it needs further details.

Embodiments of the systems and methods described in detail herein provide numerous improvements over prior systems and methods. For example, in some embodiments, AI computational inferences may be processed and missing information needed to complete the task at hand may be extracted. As understood herein, an AI computational inference is the term for how an AI model applies logic to produce an output that explains what the AI model understands from the user's request, and what steps are required to answer it.

In some embodiments, to extract missing information, when the AI model detects that a parameter is needed but not given, the AI model may be configured to use its cognitive skill to decide if there are other functions that can supply the missing parameter, or if the parameter must be provided by the user. Based on the output of the AI model, the application code may then run the necessary function to retrieve the missing input.

Embodiments of the systems and methods described herein may be configured to retrieve missing data or information from the end user. Based on the description of the functions and their parameters, the AI model may be configured to understand how to use those functions and parameters. For example, there may be a function called get_account_details that states, e.g., “Use this to get details about an account such as its balance or its holdings. This requires the account number as an input.” If the user asks, for example, “what is the current balance on my account?”, the AI model may determine that it should use the get_account_details function, but it first requires the account number parameter. Accordingly, the system may check if there are any functions that could provide the account number, or if it has been mentioned in the recent conversation history. If not, then the AI model may determine that it must request the user provide the account number.

Embodiments of the systems and methods described herein may be configured to call additional functions or APIs needed to collect missing data and complete the task. In some embodiments, the system may apply AI model reasoning to assess a user utterance and the function description, input, and output definitions that are available. This may enable the system to decide which function or sequence of functions to invoke to generate a response or output.

Embodiments of the systems and methods described herein may provide a framework that is not bound by predefined workflows or conversation flows, but rather may adapt to the dynamic and unpredictable nature of human interaction.

Embodiments of the systems and methods described herein may orchestrate and execute required actions defined in an AI model computational inference process. A computational inference process, as understood herein, is a series of computational inferences generated by the AI model in order to generate an answer to the user's question. The initial computational inference is typically composed of what the AI model is currently considering about the user's query, and what may potentially be the required action to take (for example, whether it needs to give an instruction to execute a function, or ask the user for additional detail). The application code may execute the action suggested by the initial computational inference, and the AI model may be prompted again to generate the next computational inference/action, but this time it may include the result of the previous action that was performed. In some embodiments, the AI model may generate the next computational inference, and evaluate if it has all the information needed to generate an answer; otherwise, it will return another action to perform. GPT4-32K and GPT4-Turbo are examples of AI models which, in various embodiments, may be capable of generating the required computational inference process. Various LLMs may be implemented in various embodiments as well.

Embodiments of the systems and methods described herein determine and deliver the final answer to the end user, without the need to develop a BPM process to handle conversation flow.

These and other aspects are described with reference to the drawings.

Embodiments of the systems and methods described herein may incorporate one or more existing AI models that are configured to process user messages, including utterances, e.g., voice expressions, sounds, speech, etc., and/or other forms of user communications, and generate a computational inference process. In some embodiments, an existing AI agent framework may be implemented to run LLM models and consume custom plugins that may be chained together for execution. In some embodiments, Software Development Kits (SDKs) that support function calling (e.g., that are capable of invoking functions that the AI model (e.g., LLM) instructs it to execute) may be implemented. Plugins herein refer to a logical grouping of functions, e.g., an account_statement plugin may consist of a get_accounts function and a send_statement function. The term “chained” in this context may refer to executing the functions in a sequence, passing the output of one function as an input to the next, etc. In some embodiments, the AI model may be capable of producing outputs that are required for ReAct prompting methodology.

The various embodiments described herein provide technical improvements to presently available systems by providing at least the following: (1) capability to analyze an AI's computational inference process and detect missing information or data in order to generate a response to a user's inquiry or question. The system can analyze the dialogue and can recognize the users'queries and replies; (2) ability to determine if the missing information can be retrieved by calling a function or an API; (3) capability to determine that the missing information should come from the user (in which case, the system may suspend the computational inference process to get the details from the user, ask the user for information, and then resume the computational inference process with the new information included); and (4) ability to reference information or data from the existing conversation or session.

In further embodiments, the API repository (API store) may be leveraged as the source of information for AI. As described herein, an API store may contain may APIs applications which may be relied on by other systems. These APIs may be for front end, back end, and batch processing to access and modify data directly from the data source. Embodiments described herein may use the API repository as the knowledge base of AI applications. Instead of using AI datasets as the foundation for knowledge, in some embodiments, the knowledge may come from the list of APIs with its descriptions, parameter, and expected outputs. These embodiments enable the AI application to use the API definitions and their inputs and outputs to determine what API or sequence of APIs to call to satisfy the user request. Furthermore, the API may access the data from different backend systems, and/or may use the appropriate APIs to access or update the information that is needed. In some embodiments, the AI system may also learn from the API definitions and their inputs and outputs, and use natural language processing and reasoning techniques to determine what API or sequence of APIs to call to satisfy the user request.

Embodiments of the systems and methods described in detail herein provide numerous improvements and benefits over prior systems and methods, including at least: leveraging an entity's existing API repositories as the source of information for an AI system; reducing or eliminating the need of teaching the AI model (e.g., LLM); availability of the data through the APIs; simplifying or avoiding the creation of workflows for complicated tasks; providing an AI model to use APIs for executions to carry out reading and transactional operations; using the API's data output as a basis for the AI model to generate the response; use of API's parameter definition as a basis for all the required user inputs.

Embodiments of the systems and methods described herein dynamically load a required set of functions based on intent of the question, which may further improve performance for the systems and methods described herein. In some embodiments, the processor may be configured to load only the functions that will be used and no other functions for the given question, improving both response time and reduced sent tokens.

Those with skill in the art will appreciate that inventive concepts described herein may work with various system configurations. In addition, various embodiments of this disclosure may be made in hardware, firmware, software, or any suitable combination thereof. Aspects of this disclosure may also be implemented as instructions stored on a machine-readable medium, which may be read and executed by one or more processors. A machine-readable medium may include any mechanism for storing or transmitting information in a form readable by a machine (e.g., a computing device, or a signal transmission medium), and may include a machine-readable transmission medium or a machine-readable storage medium. For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions.

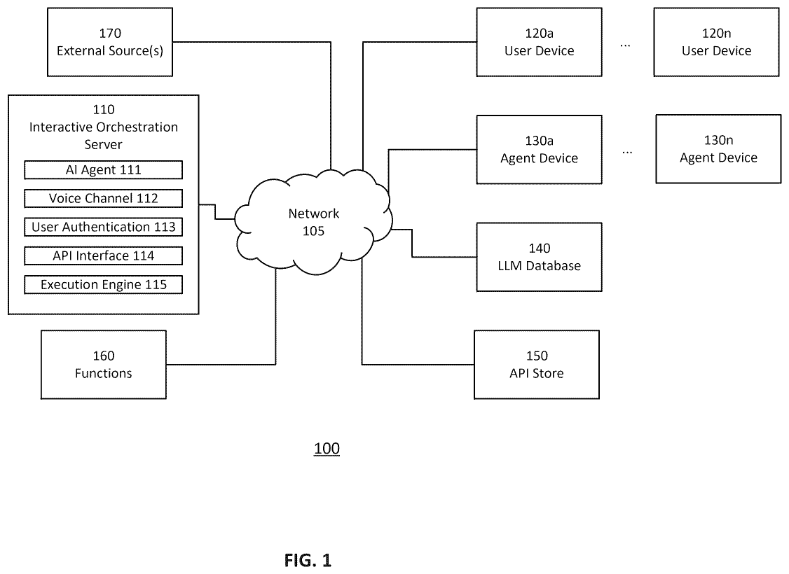

FIG. 1 depicts an illustrative system for orchestrating interaction with an AI application, in accordance with at least one embodiment. FIG. 1 illustrates a functional block diagram of an embodiment of an interactive orchestration system 100 within which at least some of the disclosed techniques may be implemented. The interactive orchestration system 100 may be established and/or configured to enable and/or facilitate automated or semi-automated interaction between users and AI applications, via network 105, as described herein.

In some embodiments, various devices and applications described herein may be configured to communicate via network 105. In some embodiments, computing devices and servers described herein may communicate over network 105, which, in various embodiments, may be any of a diverse range of networks, each tailored to specific needs: Local Area Networks (LANs) linking devices within a confined area such as a home or office; Wide Area Networks (WANs) connecting devices across larger geographical areas, such as cities or countries; Metropolitan Area Networks (MANs) serving as intermediaries, connecting LANs within a city or region; wireless networks; cellular networks; Storage Area Networks (SANs); and/or Virtual Private Networks (VPNs) secure data over public networks. In some embodiments, network 105 may be any combination of the above, which may be a combination of private and public networks.

In some embodiments, each of the elements of interactive orchestration system 100 may be or may include applications executed on respective computing systems, though this need not always be the case. In some examples, one or more of the applications may be executed on a single computing system (which is not to suggest that such a computing system may not include multiple computing devices or nodes, or that each computing device or node need be co-located; indeed, a computing system including multiple servers that house multiple computing devices may be operated by a single entity and the multiple servers may be distributed, e.g., geographically). For example, in some embodiments, an entity may execute various AI related applications and/or functionalities on a server or other computing system, e.g., interactive orchestration server 110. Moreover, in some examples, the entity may also provide users access to an AI application on various user devices (e.g., devices 120, 130, described herein), which may be a web-based application hosted by a computing system managed by or provisioned by the entity, or which communicates with such a computing system via an application programming interface (API) or other interface. Accordingly, one or more of the devices/systems/elements depicted herein may communicate with one another via messages or other data communications transmitted over network 105, such as the Internet and/or various other local area networks. For example, one or more applications may communicate via messages transmitted over network 105.

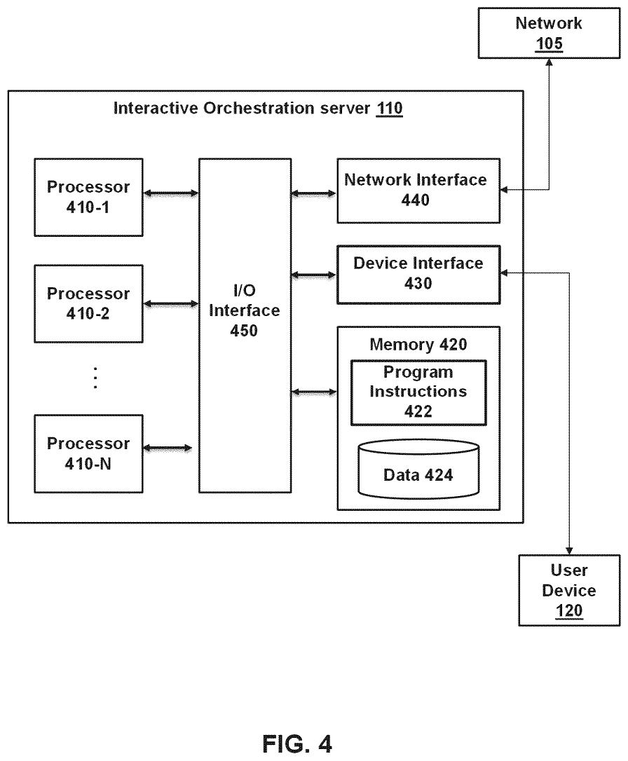

In some example embodiments, interactive orchestration server 110 may include, host, or otherwise execute one or more of a plurality of applications, including, e.g., an AI agent 111, a voice channel application 112, a user authentication application 113, an API Interface application 114, and an execution engine 115. In some embodiments, AI agent 111 may facilitate communication and other interactions with users, e.g., user device 120, agent device 130, etc. and other elements of interactive orchestration system 100, as described herein. In some embodiments, a voice channel application 112 may facilitate interactions between user device 120 and agent device 130, as described herein. In some embodiments, user authentication application 113 may provide authentication of users accessing and/or interacting with interactive orchestration system 100. In some embodiments, an API Interface application 114 may facilitate API communication between interactive orchestration server 110 and other elements of interactive orchestration system 100, including LLM database 140 and API store 150, as described herein. In some embodiments, execution engine 115 may execute or facilitate underlying functionality, including generation of results (e.g., answers) and delivery of communications across interactive orchestration system 100. It should be noted that, in various embodiments, interactive orchestration server 110 may be any computing system, as described in detail with reference to FIG. 4, herein.

In some embodiments, interactive orchestration system 100 may include one or more user device(s) 120. As shown in FIG. 1, interactive orchestration system 100 may include user devices 120a-120n (collectively referred to as “user devices 120” and individually referred to as “user device 120,” interchangeably), Each user device 120 may include any type of mobile terminal, fixed terminal, or other device(s). By way of example, user device 120 may include a desktop computer, a notebook computer, a tablet computer, a smartphone, a wearable device, or other client device, having therein one or more processors, memory, and one or more code sets stored in the memory and executed by the one or more processors. Users may, for instance, utilize one or more user devices 120 to interact with one another, one or more servers, or other components of interactive orchestration system 100.

In some embodiments, interactive orchestration system 100 may include one or more agent device(s) 130. As shown in FIG. 1, interactive orchestration system 100 may include agent devices 130a-130n (collectively referred to as “agent devices 130” and individually referred to as “agent device 130,” interchangeably). Each agent device 130 may include any type of mobile terminal, fixed terminal, or other device(s). By way of example, agent device 130 may include a desktop computer, a notebook computer, a tablet computer, a smartphone, a wearable device, or other client device, having therein one or more processors, memory, and one or more code sets stored in the memory and executed by the one or more processors. Users (in this case, agents, e.g., of an entity) may, for instance, utilize one or more agent devices 130 to interact with one another, one or more servers, or other components of interactive orchestration system 100.

It should be noted that, while one or more operations are described herein as being performed by particular components of interactive orchestration server 110, those operations may, in some embodiments, be performed by other components of interactive orchestration server 110 or other components of interactive orchestration system 100. As an example, while one or more operations are described herein as being performed by components of interactive orchestration server 110, those operations may, in some embodiments, be performed by components of user device 120, agent device 130, LLM database 140, API store 150, etc.

In some embodiments, interactive orchestration system 100 may include LLM database 140. As explained herein, an LLM database is a specialized database that leverages the capabilities of one or more LLMs to enhance data interaction and management. Of course, in various embodiments, other AI models may be implemented, in addition to and/or in place of one or more LLMs.

In some embodiments, interactive orchestration system 100 may include API store 150. In various embodiments, API store 150 may be or may include a platform for accessing various APIs (Application Programming Interfaces). In some embodiments, API store 150 may provide a centralized location for APIs to be published and for the system to find and access APIs that meet specific needs. In some embodiments, API store 150 may include features such as search functionality, categorization, usage documentation, etc. In some embodiments, API interface 114 may access or otherwise query API store 150, in order to implement or access a given API from API store 150. It should be noted that some APIs may be internal while some may be external, with respect to interactive orchestration system 100.

In some embodiments, interactive orchestration system 100 may include a functions database 160. As understood herein, functions database 160, may be a database or other repository storing various functions which may be implemented in various embodiments. As noted herein, a function is a segment of code that performs a specific task or operation, typically by taking some input parameter(s) and returning an output value. Accordingly, in various embodiments, depending on the input received by interactive orchestration server 110, one or more functions may be necessitated to perform some defined task or operation.

In some embodiments, interactive orchestration system 100 may include one or more external source(s) 170. As understood herein, external source(s) 170 may be a collection of one or more applications, databases, and/or systems which execute, interact with, or otherwise provide functions, data, and/or information which may be related to user queries. It should be noted that, in some embodiments, external source(s) 170 may be external to interactive orchestration server 110 and yet may be internal to an organization or entity (e.g., separate systems, databases, etc.), or may be external to the organization or entity (e.g., third-party resources, companies, databases, etc.). Furthermore, in some embodiments, API store 150 may be connected to or otherwise configured to interact with one or more of external sources 170.

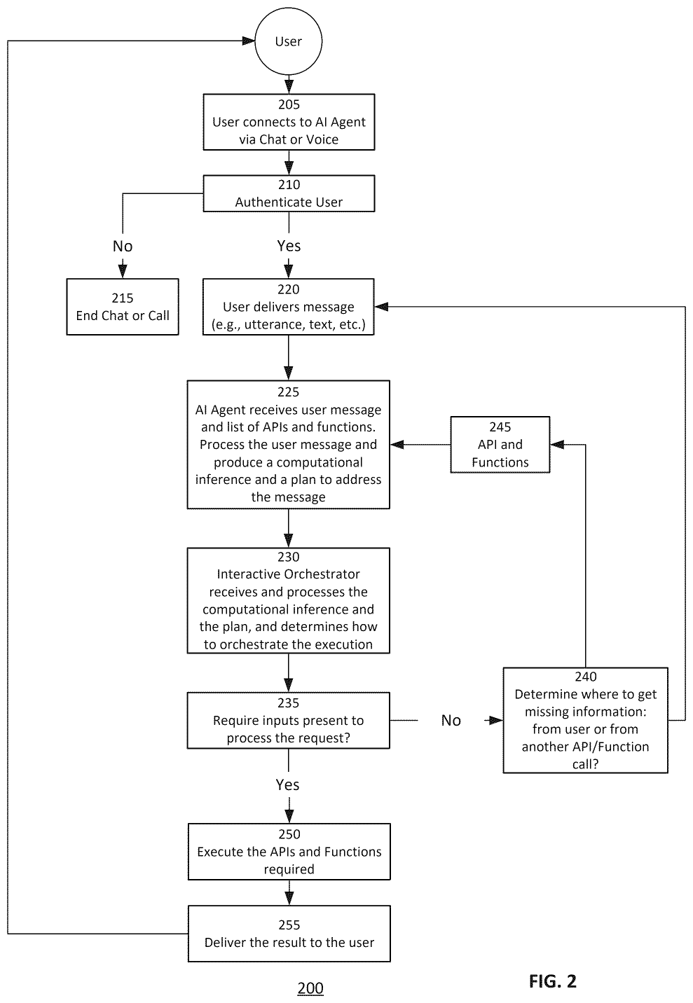

These and other features of interactive orchestration system 100 will be further understood with reference to method 200 of orchestrating interaction with an AI application of FIG. 2, herein.

FIG. 2 depicts an example method 200 for orchestrating interaction with an AI application, in accordance with at least one embodiment. In various embodiments, method 200 may be implemented by interactive orchestration system 100, executing code in one or more processors therein. For example, in some embodiments, method 200 may be performed on a computer (e.g., computing system 400 of FIG. 4) having one or more processors (e.g., processor(s) 410 of FIG. 4) and memory (e.g., system memory 420 of FIG. 4), and one or more code sets, applications, programs, modules, and/or other software stored in the memory and executing in or executed by one or more of the processor(s).

Method 200 begins at step 205 when a user starts an interaction with an AI agent, such as, via Chat or Voice Channel. In some embodiments, a processor may receive an indication or communication for a user device of a user, informing the system of the user's intent to access the system. In some embodiments, a user device (e.g., user device 120) may initiate a connection to the AI system, e.g., via a request through an application or web browser, which then (at step 210) sends this request over the network to a user authentication application, e.g., user authentication application 113. This request may include necessary information such as the device's IP address, the desired service endpoint, and any required authentication credentials. The server may process the request, verify the credentials, and check if the user has the necessary permissions. If the authentication process fails, then, at step 215, in some embodiments, the connection is terminated (e.g., the chat is ended or the call is disconnected). Alternatively, upon successful verification, at step 220 the user may be prompted to deliver an initial message (e.g., utterance, text message, etc.), or a response to an AI question.

It should be noted that there are various ways a user may interact with and provide messages or other data transmissions to an AI agent. For example, in some embodiments, the user may employ the user device to record a voice message or other utterance, which may be delivered to the AI agent (e.g., as an audio recording). In other embodiments, the user may employ the user device to input a text-based message or other digital response via an input of the user device, e.g., a keyboard, mouse click, touchscreen, camera, etc., which may then be transmitted to the AI agent (e.g., as text or other media).

In some embodiments, at step 225, the AI agent may receive the initial message, such as an utterance or other response (referred to herein collectively as a data transmission or message) from the user. For example, AI agent 111 of interactive orchestration server 110 may receive a data transmission via network 105 from user device 120. Upon receipt of the data transmission, in some embodiments, the processor may be configured to process the data transmission (e.g., the utterance or text response) and determine which API(s) and/or function(s) may be required in order to answer or otherwise respond to the data transmission. To make this determination, in some embodiments, application code may define the functions, descriptions, parameters, and/or implementation that may be used by the system. Accordingly, when the data transmission is received, in some embodiments, an LLM prompt may be created, which includes the list of function names, descriptions, parameters, e.g., and provides this information to the AI agent, including a list of APIs and functions that are required.

In some embodiments, the prompt that the AI agent sends to the LLM may include instructions on what the LLM is to do with the prompt (e.g., generate a computational inference process), along with the user's message (request or response). In some embodiments, the AI agent may then process the initial user utterance or additional response, and produce a computational inference process or plan to address the user request or additional response.

By way of example, the following computational inference may be generated by the AI agent:
[COMPUTATIONAL INFERENCE] “The user is asking for their account balance. I can obtain this information using the get_account_details function, however it requires the account number which the user did not provide. According to the guidelines, I can ask the user to select from a list of available accounts. I can use the get_account_list function to get that list.”
[ACTION] action: get_account_list; Inputs: [null]; User_id: abc123.

The computational inference process is a series of computational inferences similar to the above. The following is an example of the next computational inference that may be generated in an example embodiment, after the above example:
[COMPUTATIONAL INFERENCE] “The user is asking for their account balance. I can obtain this information using the get_account_details function, however it requires the account number which the user did not provide. According to the guidelines, I can ask the user to select from a list of available accounts. I can use the get_account_list function to get that list.
[ACTION] action: get_account_list; Inputs: [null]; User_id: abc123
[OBSERVATION] 456001, 456002, 456003
[COMPUTATIONAL INFERENCE] “Now that I have the list of accounts, I can ask the user to select which one to use. I can use the get_additional_details_from_user function for this.”
[ACTION] action: get_additional_details_from_user; Inputs: [null]; User_id: Please select which of these accounts: 456001, 456002, 456003

As noted above, in some embodiments, the AI agent may be configured to generate a plan to address the computational inference. Referring to the previous example question/response, which would be this part of the example computational inference, the following may be generated in some embodiments:
[COMPUTATIONAL INFERENCE] “The user is asking for their account balance. I can obtain this information using the get_account_details function, however it requires the account number, which the user did not provide. According to the guidelines, I can ask the user to select from a list of available accounts. I can use the get_account_list function to get that list.”

In some embodiments, the AI agent may be able to produce the plan because of the way the LLM was prompted, e.g., portions of the prompt may be responsible for certain tasks such as, e.g., “Answer the user's question using the functions provided,” “Use the get_additional_details_from_user function if you need to ask the user to provide additional details,” “Break down the problem step-by-step and think about the best approach,” etc.

Next, at Step 230, in some embodiments, the interactive orchestration server may be configured to process the initial and/or and subsequent computational inference process and plan, and determine how to orchestrate the plan.

To make this determination, in some embodiments, the processor may query the LLM to evaluate the user's request and use its artificial cognitive ability to determine, e.g., if: (1) it already has all the information needed to respond to it; (2) if any of the available APIs and/or functions are capable of producing the information needed to generate an answer; (3) if it does not have any way to produce the answer; and/or (4) if what the user is asking for does not make sense. Depending on the scenario, for example: (1) it may generate an answer; (2) it may check if it has all the available parameters, and then it may generate an output that specifies which function/parameters to execute; otherwise, it may assess if any other functions can be used to derive that missing parameter. If there are no functions that can be used, then it may produce an output with an instruction to ask the user to provide the required information; (3) respond to the user to say that it is not able to give an answer; and/or (4) respond to the user to clarify what is being asked.

Next, at step, 235, in some embodiments, the processor may determine whether or not all required information is present to process the request. If it is determined that missing information required, then at step 240, in some embodiments, the processor may be configured to determine from where to retrieve missing information, e.g., from the user directly, or from another API and/or function call. In some embodiments, if the information can be retrieved from an API and/or function call, then, at step 245, the processor may initiate the call, e.g., to additional APIs and/or functions. Upon receipt, in some embodiments, the processor may pass the information back to the AI agent to regenerate the computational inference and plan with the newly collected information.

Alternatively, in some embodiments, if, at step 240, it is determined that the information cannot be retrieved from an API and/or function call and missing information must be collected from the user, then, in some embodiments, the processor may be configured to generate a reply which asks the user for missing information, which may be provided as outlined in step 220 herein. Once an additional response is received, the processor may provide the information back to the AI agent to regenerate the computational inference and plan with the newly collected information and again determine if all required inputs are present to process the request (step 235). If the request still cannot be processed then, in some embodiments, the processor may repeat the process, e.g., until all information is received or until a threshold number of attempts have been make (at which time, e.g., an alert may be sent and/or the process may be terminated), a partial response may be proposed, etc. If the processor determines that the required inputs are present, then at step 250 the processor may be configured to execute the requisite API and/or functions to complete the request, and at step 255 the result may be delivered to the user device.

In some embodiments, the LLM prompting may be designed so that the output will indicate if a final answer has been determined, or a partial answer. A portion of an example prompt responsible for this determination is provided below:
[FINAL ANSWER] “Once I have gathered all the necessary observations and performed any required actions, I can provide the final answer in a clear and human-readable format.” [END COMPUTATIONAL INFERENCE PROCESS]In some embodiments, the system may implement further processes to evaluate the accuracy of the response, e.g., by accessing other APIs, functions, and/or other external resources (e.g., 3rd party databases or platforms, etc.).

In some embodiments, e.g., when a threshold number of attempts have been made, or when a completeness threshold has been reached (e.g., some amount more than zero percent and less than 100 percent), rather than terminating the process, other steps may be taken, e.g., generating a partial result, alerting an agent device to intervene, etc.

Embodiments described herein may be implemented in the context of a contact or call center task by replacing at least a portion of the conventional BPM workflows. Embodiments may enable a complete dialog interaction between the end user and an AI agent, transforming the contact center operations by using the power of AI. In some embodiments, the framework may adjust to the flexible and uncertain nature of human communication, instead of being constrained by preset workflows or conversation flows, generate and process AI computational inferences based on the user request, and extract missing information needed to complete the task at hand. Finally, the process may determine the needed API or function execution to provide the final answer to the user.

For example, in some embodiments, a phone network and session management system may be leveraged to route calls a voice engine that handles VTT and TTV conversions. Such messages may be routed to an API gateway (e.g., via API interface 114). In some embodiments, the message may be directed to e.g., a dedicated contact center AI agent. In some embodiments, the contact center AI agent may process the utterances to generate a computational inference process, as described in detail with reference to FIG. 2 herein. In some embodiments, once the processor executes the requisite API and/or functions to complete the request, the system may be configured to log all conversation to a database, e.g., to be applied to future calls/messages. In some embodiments, conversations may be routed to a live contact center agent using the call manager, e.g., if the request is not supported by the contact center AI agent, or if only a partial reply can be generated.

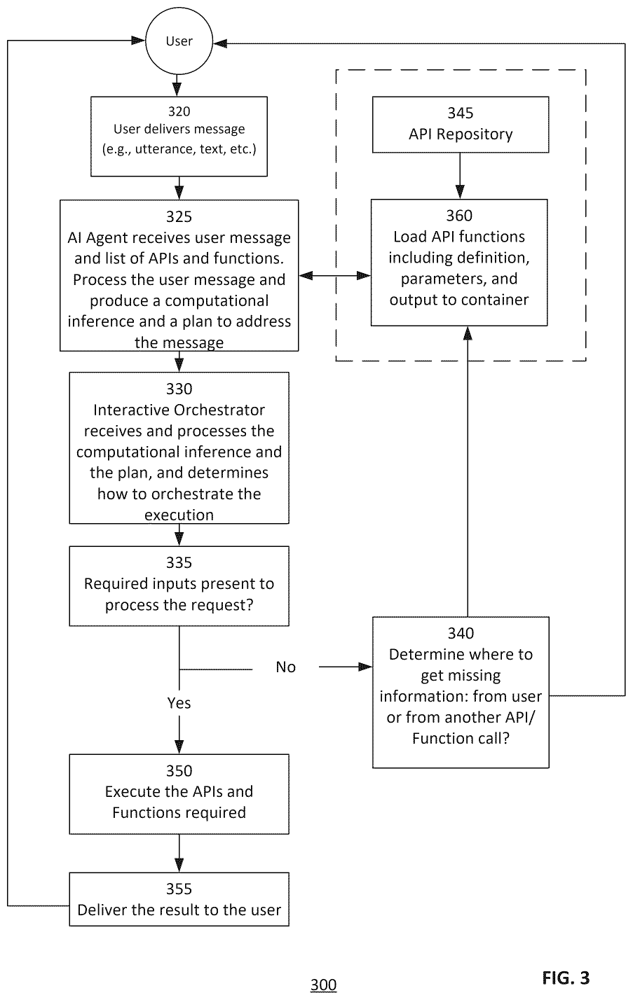

Turning briefly to FIG. 3, an alternative example method 300 for orchestrating interaction with an AI application is depicted, in accordance with at least one embodiment. In various embodiments, method 300 may be implemented by interactive orchestration system 100, executing code in one or more processors therein. For example, in some embodiments, method 200 may be performed on a computer (e.g., computing system 400 of FIG. 4) having one or more processors (e.g., processor(s) 410 of FIG. 4) and memory (e.g., system memory 420 of FIG. 4), and one or more code sets, applications, programs, modules, and/or other software stored in the memory and executing in or executed by one or more of the processor(s).

In some embodiments, method 300 may be largely similar to method 200 (FIG. 2). In particular, the descriptions of steps 220-255 may correlate with the descriptions of steps 320-355, and are therefore not repeated here to avoid redundancy.

As noted herein, in some embodiments, the API repository (e.g., API store) may be leveraged as the source (or a source) of information for the AI agent. Accordingly, in some embodiments, the API store may contain many APIs applications which may be relied on by other systems. These APIs may be for front end, back end, and batch processing to access and modify data directly from the data source. Embodiments described herein may use the API repository as a knowledge base of AI applications.

As noted in step 360, in some embodiments, instead of (or in addition to) using AI datasets as the foundation for knowledge, in some embodiments, the knowledge/data may come from the list of APIs that are stored in the repository, with its descriptions, parameters, and expected outputs of the various APIs. These embodiments enable the AI application to use the API definitions and their inputs/outputs to determine what API or sequence of APIs to call to satisfy the user request. In some embodiments, the processor may be configured to load relevant API/functions, including definitions, parameters, and/or outputs to an AI application (e.g., Semantic Kernel® or other AI agent software development kit (SDK)). This information may then be used by the processor (at step 325) in reconsidering the data transmission from the user device. In some embodiments, the API may access the data from different backend systems and/or AI datasets (referred to herein as secondary sources), and/or may use the appropriate APIs to access or update the information that is needed, in addition to the data from the list of APIs. In some embodiments, the AI system may also learn from the API definitions and their inputs and outputs, and use natural language processing and reasoning techniques to determine what API or sequence of APIs to call to satisfy the user request.

It should be noted that this alternative method 300 (or elements thereof) may be implemented in the context of a call center as well. For example, embodiments may leverage an entity's API store as the knowledge base, using the API definitions, parameters, and output to an AI container. In some embodiments, a dedicated contact center AI agent may be provided access to the APIs of AI containers, which may be grouped based on transaction types. In some embodiments, a contact center AI agent may select the appropriate AI container based on the user utterance, e.g., leveraging a ReAct framework for processing the API of the relevant AI container(s). In some embodiments, messages may be sent to the contact center AI agent, which may be running via e.g., Semantic Kernel and ReAct.

In some embodiments, the AI agent may process the utterance to generate a computational inference process, as described in detail herein. The computational inference process generated may act as the initial plan to address the user's request, including: evaluating generated computational inferences; determining if there is any missing information to process the request; asking the user or initiating an additional API/Function call to retrieve the information required; sending the information back to the contact center AI agent to re-process the computational inference; determining if the computational inference is complete; executing the plan by executing the API and functions; and delivering the final answer to the user.

Returning to FIG. 2, in some embodiments, the processor may be configured to dynamically load a required set of functions based on intent of the question. In some embodiments, the processor may be configured to load only the functions that will be used and no other functions for the given question, improving both response time and reduced sent tokens.

In a framework such as one designed to enhance AI systems utilizing machine learning and natural language processing techniques to interpret the nuances of language and user intent (e.g., a reason for a user communication, a topic of an interaction, etc.) ), all the available plugins and functions may be added to a given prompt (e.g., modifying the message) so the LLM is made aware of them and can process them. Embodiments described herein may be configured to add one or both of the following two functions, or functional equivalents thereof, to a given prompt (including the names and descriptions):
Name GetIncidentDetails
Description: “This prompt retrieves the details of incidents or issues or the number of incidents using the filters provided. Summarize the output of this function in plain English. If required, filter the result further to provide only the intended incidents.”
Name GetProjectForMnemonic
Description: Returns a list of projects related to the specified mnemonic. If someone is looking for a project based on mnemonic call this. If a user asks for a link to a jira issue, project, or epic, the base jira url may be provided at [URL].

In some embodiments, e.g., when the system knows beforehand which plugins and functions are needed to respond a certain user question, there is no need to have them all in the prompt. Instead, a much cleaner, lower-resource, and more efficient approach is to only load the ones we will use.

Embodiments of the systems and methods described herein may be used for various purposes. For example, by running them on different questions from the user the system may be configured to determine if the “intent” of the user changed. For example, if, after running question A the identified plugins were W and X, and after running question B the identified plugins were Y and Z, there is no overlap on the plugins nor user intent, which may indicate the user moved on to another subject. This may allow the system to manage chat history in a more accurate way, by removing parts of the conversation that are no longer relevant.

In some embodiments, two AI containers may be provided, which enable interacting with an LLM), the interaction orchestration system described in detail herein (which, in some embodiments, may function as an AI container or other AI application) and a “lean” AI container. As explained herein, the interaction orchestration system is able to identify the plugins and functions but is not able, on its own, to identify which functions are going to be called ahead of time (it is used only to make a prompt LLM call that will figure out what plugins to load into a second “lean”AI container.

In some embodiments, this may be implanted programmatically, e.g., by gathering the metadata of the plugins/functions and setting them in a JSON object (as may occur with respect to the interactive orchestration system AI container with the function names and descriptions). In some embodiments, the processor may be configured to feed the function names and descriptions that are available in order to respond to the user question, but not a planner (e.g., a software component or mechanism that helps organize and manage the tasks or actions that the model needs to perform to achieve a specific goal).

In some embodiments, the processor may request that the interactive orchestration system AI container ignore or otherwise “pretend” that those plugins/functions are the ones the interactive orchestration system AI container has available, and return all and only the plugins/functions that it will need to respond.

In some embodiments, the processor may ask a planner application to “pretend” that the gathered functions are available in its AI container. An example prompt is provided here: (plugins_metadata_native is the variable that holds the functions names and descriptions): “Pretend that the plugins and functions in plugins_metadata_native variable are available in your AI container. Please return all of the semantic functions (in the format <functionNameA>, <functionNameB>, <functionName3> that you need to use to respond the given question . . . ”

In some embodiments, once the processor has those plugins/functions, they may be loaded into the lean AI container, and the processor may request that the lean AI container execute a computational inference process (e.g., use the planner, which it did not use previously) only with those plugins/functions attached to it (eventually becoming part of the prompt).

It should be noted that this should be called on each question since, the user might change (partially or completely) the question intent, so that the system may determine what plugins/functions to load on every question.

FIG. 4 is a diagram that illustrates an exemplary computing system 400 in accordance with embodiments of the present technique. Various portions of systems and methods described herein, may include or be executed on one or more computing systems similar to computing system 400. Further, processes and modules described herein may be executed by one or more processing systems similar to that of computing system 400. For example, interactive orchestration server 110 may execute operations using a processing system that is the same or similar to computing system 400.

Computing system 400 may include one or more processors (e.g., processors 410-1-410-N) coupled to system memory 420, an input/output I/O device interface 430, and a network interface 440 via an input/output (I/O) interface 450. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 400. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 420). Computing system 400 may be a uni-processor system including one processor (e.g., processor 410-1), or a multi-processor system including any number of suitable processors (e.g., 410-1-410-N). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 400 may include a plurality of computing devices (e.g., distributed computing systems) to implement various processing functions.

I/O device interface 430 may provide an interface for connection of one or more I/O devices to computing system 400. I/O devices may include devices that receive input (e.g., from a user) or output information (e.g., to a user), such as user devices 120. I/O devices may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices may be connected to computing system 400 through a wired or wireless connection. I/O devices may be connected to computing system 400 from a remote location. I/O devices located on remote computer system, for example, may be connected to computing system 400 via a network, e.g., network(s) 105, and network interface 440.

Network interface 440 may include a network adapter that provides for connection of computing system 400 to a network. Network interface 440 may facilitate data exchange between computing system 400 and other devices connected to the network. Network interface 440 may support wired or wireless communication. The network, such as for example network(s) 105, may include an electronic communication network, such as the Internet, a local area network (LAN), a wide area network (WAN), a cellular communications network, or the like.

System memory 420 may be configured to store program instructions 422 or data 424. Program instructions 422 may be executable by a processor (e.g., one or more of processors 410-1-410-N) to implement one or more embodiments of the present techniques. Program instructions 422 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. a computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 420 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 420 may include a non-transitory computer readable storage medium that may have program instructions stored thereon that are executable by a computer processor (e.g., one or more of processors 410-1-410-N) to cause the subject matter and the functional operations described herein. A memory (e.g., system memory 420) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 450 may be configured to coordinate I/O traffic between processors 410-1-410-N, system memory 420, network interface 440, I/O devices, and/or other peripheral devices. I/O interface 450 may perform protocol, timing, or other data transformations to convert data signals from one component (e.g., system memory 420) into a format suitable for use by another component (e.g., processors 410-1-410-N). I/O interface 450 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 400 or multiple computing systems 400 configured to host different portions or instances of embodiments. Multiple computing systems 400 may provide for parallel or sequential processing/execution of one or more portions of the techniques described herein.

Those skilled in the art will appreciate that computing system 400 is merely illustrative and is not intended to limit the scope of the techniques described herein. Computing system 400 may include any combination of devices or software that may perform or otherwise provide for the performance of the techniques described herein. For example, computing system 400 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 400 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 400 may be transmitted to computing system 400 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include,” “including,” and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring.

Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square,” “cylindrical,” and the like, should be construed as encompassing items that substantially embody the properties of the geometric construct, e.g., reference to “parallel”surfaces encompasses substantially parallel surfaces.

The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish, or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

What is claimed is:

1. A method for orchestrating interaction with an artificial intelligence application in a contact center environment, comprising:
receiving, by a processor, via an artificial intelligence (AI) agent, a first voice message from a user;
converting, by the processor, the first voice message to a first text message;
generating, by the processor, an initial computational inference process based at least in part on the first text message;
determining, by the processor, whether or not all information required to execute the initial computational inference process is available to the processor;
when a determination is made that all information required to execute the initial computational inference process is available to the processor:
executing, by the processor, the initial computational inference process;
generating, by the processor, a first text reply based on the initial computational inference process;
converting, by the processor, the first text reply to a first voice reply; and
sending, by the processor, the first voice reply to the user via the AI agent;
when a determination is made that not all information required to execute the initial computational inference process is available to the processor:
generating, by the processor, a first text query requesting the unavailable information from the user;
converting, by the processor, the first text query to a first voice query; and
sending by the processor, the first voice query to the user via the AI agent.

2. The method as in claim 1, further comprising:
receiving, by the processor, via the AI agent, a second voice message from a user;
converting, by the processor, the second voice message to a second text message;
generating, by the processor, a revised computational inference process based at least in part on the second text message;
executing, by the processor, the revised computational inference process;
generating, by the processor, a second text reply based on the revised computational inference process;
converting, by the processor, the second text reply to a second voice reply; and
sending, by the processor, the second voice reply to the user via the AI agent.

3. The method as in claim 1, wherein the first voice message is converted to the first text message via a voice-to-text (VTT) engine.

4. The method as in claim 1, wherein the first text replay is converted to the first voice reply via a text-to-voice (TTV) engine.

5. The method as in claim 1, wherein, when determining whether all required information is available, the processor is further configured to determine at least one of:
which API or APIs of a plurality of APIs is required to respond to the first voice message; or
which function or functions of a plurality of functions is required to respond to the first voice message.

6. The method as in claim 1, wherein the AI agent is further configured to analyze the user's voice message for at least one of tone, sentiment, or urgency, and modify the computational inference process based at least in part on the detected sentiment to prioritize urgent requests or escalate the interaction to a human agent.

7. The method as in claim 1, wherein determining whether all required information is available further comprises querying a historical conversation database to retrieve prior interactions with the user, and using previously provided information to supplement the computational inference process before requesting additional user input.

8. The method as in claim 1, wherein generating the first text query further comprises structuring the query dynamically based on natural language processing (NLP) techniques before converting the text query to a voice query.

9. The method as in claim 1, further comprising verifying the accuracy of the voice-to-text conversion by applying an AI-based confidence scoring mechanism, and in response to detecting a low confidence score, prompting the user to confirm or clarify the converted message before proceeding with computational inference.

10. The method as in claim 1, wherein the processor is further configured to determine whether the AI agent should rephrase or simplify the first voice reply based on the complexity of the generated response and the user's past interaction history, ensuring responses are tailored to the user's preferred communication style.

11. A system for orchestrating interaction with an artificial intelligence application in a contact center environment, comprising:
a computer having a processor and a memory; and
one or more code sets stored in the memory and executed by the processor, which, when executed, configure the processor to:
receive, via an artificial intelligence (AI) agent, a first voice message from a user;
convert the first voice message to a first text message;
generate an initial computational inference process based at least in part on the first text message;
determine whether or not all information required to execute the initial computational inference process is available to the processor;
when a determination is made that all information required to execute the initial computational inference process is available to the processor:
execute the initial computational inference process;
generate a first text reply based on the initial computational inference process;
convert the first text reply to a first voice reply; and
send the first voice reply to the user via the AI agent;
when a determination is made that not all information required to execute the initial computational inference process is available to the processor:
generate a first text query requesting the unavailable information from the user;
convert the first text query to a first voice query; and
send the first voice query to the user via the AI agent.

12. The system as in claim 11, further configured to:
receive, via the AI agent, a second voice message from a user;
convert the second voice message to a second text message;
generate a revised computational inference process based at least in part on the second text message;
execute the revised computational inference process;
generate a second text reply based on the revised computational inference process;
convert the second text reply to a second voice reply; and
send the second voice reply to the user via the AI agent.

13. The system as in claim 11, wherein the first voice message is converted to the first text message via a voice-to-text (VTT) engine.

14. The system as in claim 11, wherein the first text message is converted to the first voice reply via a text-to-voice (TTV) engine.

15. The system as in claim 11, wherein, when determining whether all required information is available, the processor is further configured to determine at least one of:
which API or APIs of a plurality of APIs is required to respond to the first voice message; or
which function or functions of a plurality of functions is required to respond to the first voice message.

16. The system as in claim 11, wherein the AI agent is further configured to analyze the user's voice message for at least one of tone, sentiment, or urgency, and modify the computational inference process based at least in part on the detected sentiment to prioritize urgent requests or escalate the interaction to a human agent.

17. The system as in claim 11, wherein determining whether all required information is available further comprises querying a historical conversation database to retrieve prior interactions with the user, and using previously provided information to supplement the computational inference process before requesting additional user input.

18. The system as in claim 11, wherein generating the first text query further comprises structuring the query dynamically based on natural language processing (NLP) techniques before converting the text query to a voice query.

19. The system as in claim 11, further configured to verify the accuracy of the voice-to-text conversion by applying an AI-based confidence scoring mechanism, and in response to detecting a low confidence score, prompt the user to confirm or clarify the converted message before proceeding with computational inference.

20. The system as in claim 11, wherein the processor is further configured to determine whether the AI agent should rephrase or simplify the first voice reply based on the complexity of the generated response and the user's past interaction history, ensuring responses are tailored to the user's preferred communication style.
